(19) United States
(12) Patent Application Publication
(10) Pub. No.: US 2005/0220316 A1
(43) Pub. Date: Oct. 6, 2005

(54) Wireless earphone with alternating extension and retraction functions

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/814,126

(22) Filed: Apr. 1, 2004

(51) Int. Cl. H04B 1/28; H04B 1/00

(52) U.S. Cl. 381/315; 381/330; 381/86

(57) ABSTRACT

A wireless earphone with alternating extension and retraction functions is described. The earphone has adjustable connection lengths between an amplifier and a housing, a microphone and the housing respectively, and includes a housing having a earpiece, an amplifier, a first connection member capable of being alternatingly extended from and retracted into the housing, a microphone, and a second connection member capable of being alternatingly extended from and retracted into the housing and opposing the first connection member. The first connection member electrically connect the amplifier and the housing, while the second connection member electrically connects the microphone and the housing. The wireless earphone is applicable to alternating extension and retraction and has multiple functions, wide application and high efficiency.

### BACKGROUND OF THE INVENTION

1. Field of the Invention

The present invention relates to a wireless earphone with alternating extension and retraction functions, and particularly relates to a wireless earphone with adjustable connection lengths between an amplifier and a housing, a microphone and the housing, respectively.

2. Background of the Invention

Wireless earphones are applicable worldwide to electronic products, such as cell phones, household telephones, or computers, for convenience in the use thereof.

Referring to FIG. 1, a conventional wireless earphone 1 includes a housing 11 having an earpiece 12, an amplifier 13 arranged at an end of the housing 11, and a microphone 14 disposed at an opposing end of the housing 11. The earpiece 12 is hung on the user's ear, the amplifier 13 aligns with the earhole properly, and the microphone 14 is adjacent to the mouth of the user for sound signal reception and transmission.

However, the conventional wireless earphone 1 is fixed and has some shortcomings, as follows:

1. A distance between the amplifier 13 and the microphone 14 is fixed and a little short, the output power of the amplifier 13 is small inevitably but the feedback therebetween is accordingly avoided. Thus, the amplifier 13 cannot be arranged far from the ear, which means the conventional wireless earphone 1 can't amplify the speaker's voice.

2. Since the distance between the amplifier 13 and the microphone 14 is fixed and a little short, the conventional wireless earphone 1 cannot be placed on a speaker's clothes due to the small output power of the amplifier 13.

3. Since the distance between the amplifier 13 and the microphone 14 is fixed and a little short, the microphone 14 cannot extend to contact speaker's throat.

Hence, an improvement over the prior art is required to overcome the disadvantages thereof.

### SUMMARY OF INVENTION

The primary object of the invention is therefore to specify a wireless earphone with alternatingalternating extension and retraction functions that can provide extension and retraction thereof effectively; the wireless earphone is further adopted for amplifying the speaker's voice, clamping the wireless earphone to the clothes, and replacing a throat vibration for general applications and multiple functions.

According to the invention, these objects are achieved by a wireless earphone with alternating extension and retraction functions including a housing having a earpiece, an amplifier, a first connection member capable of being extended from and retracted into the housing, alternatingly, a microphone, and a second connection member capable of extending from and retracting in the housing, alternatingly, and opposing the first connection member. The first connection member electrically connects the amplifier and the housing. The second connection member electrically connects the microphone and the housing. The wireless earphone is capable of alternatingly extending and retracting, and has multiple functions, wide application and high efficiency.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a conventional wireless earphone;

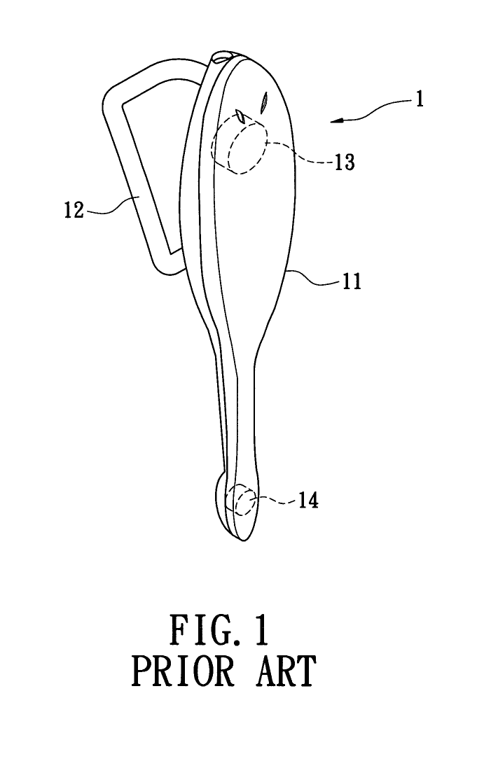

FIG. 2 is a perspective view according to a wireless earphone with alternating extension and retraction functions of the present invention in an extended state;

FIG. 3 is a perspective view according to the wireless earphone of the present invention from another angle in a retracted state;

FIG. 4 is a perspective view of an application according to the wireless earphone of the present invention;

FIG. 5 is a perspective view of a first embodiment according to the wireless earphone of the present invention;

FIG. 6 is a perspective view of a second embodiment according to the wireless earphone of the present invention; and

FIG. 7 is a perspective view of a third embodiment according to the wireless earphone of the present invention.

### DETAILED DESCRIPTION OF THE EMBODIMENTS

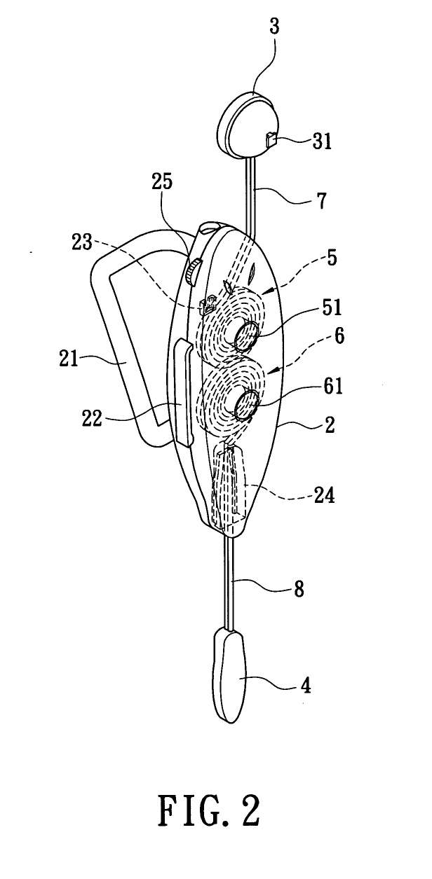

Referring to FIGS. 2 to 4, the present invention provides a wireless earphone with alternating extension and retraction functions including a housing 2 having a earpiece 21, an amplifier 3, a first connection member 5 capable of extending from and retracting into the housing 2, alternatingly, a microphone 4, and a second connection member 8 capable of extending from and retracting into, alternatingly and opposing the first connection member 7 in the housing 2. The first connection member 5 electrically connects the amplifier 3 and the housing 2, while the second connection member 8 electrically connects the microphone 4 and the housing 2. The wireless earphone is thus both extendible and retractable, and has multiple functions, wide application and high efficiency. The wireless earphone includes a first winding mechanism 5 and a second winding mechanism 6, both disposed inside the housing 2; therefore, each of the first connection member 7 and the second connection member 8 is of a cable type for electrical connection to the first winding mechanism 5 and the second winding mechanism 6, respectively.

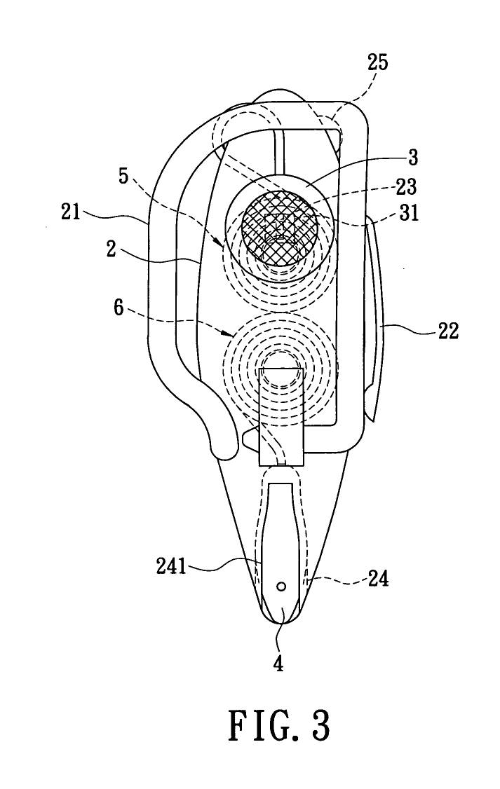

The earpiece 21 is disposed on a side of the housing 2. Each of the first connection member 7 and the second connection member 8 is of a cable type for electrical connection to the first winding mechanism 5 and the second winding mechanism 6, respectively. The housing 2 further includes an orientation slot 23 formed therein and adjacent to an upper portion thereof, a cutout 241 (in FIG. 3) formed on a lower portion thereof, a control bottom 25 disposed on a periphery thereof in a rotating manner, and a clamping member 22 arranged thereon. The housing 2 further includes an orientation recess 24 formed in the lower portion thereof, relating to and accommodating the microphone 4.

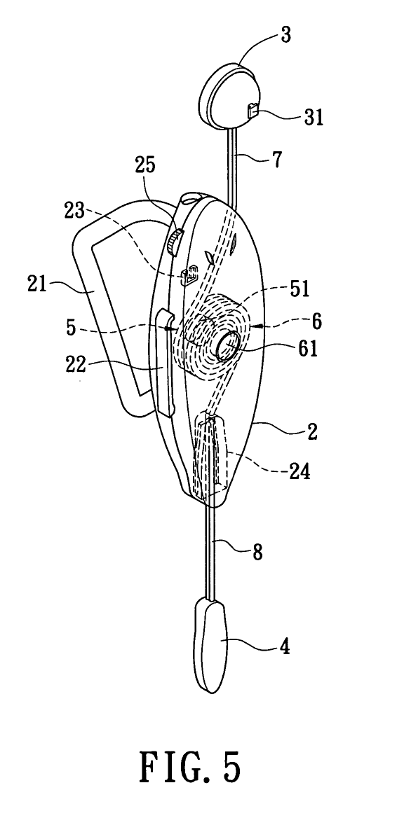

The first winding mechanism 5 and the second winding mechanism 6 wind the first connection member 7 and the second connection member 8, respectively. The first winding mechanism 5 and the second winding mechanism 6 have bottoms 51, 61 respectively exposed by the housing 2, so as to wind back an already-extended first connection member 7 and second connection member 8. The first winding mechanism 5 and the second winding mechanism 6 are separated from each other in the housing, and the first winding mechanism 5 and the second winding mechanism 6 are disposed on upper and lower portions thereof, respectively. Alternatively, the first winding mechanism 5 and the second winding mechanism 6 are parallel to each other in the housing 2, and the first winding mechanism 5 and the second winding mechanism 6 are disposed on two lateral portions of the housing 2, respectively, (in FIG. 5) for reducing space occupied.

The first connection member 7 electrically connects the amplifier 3 and the housing 2; the second member 8 electrically connects the microphone 4 and the housing 2. A circuit unit (not shown) in the housing 2 electrically connects the first connection member 7 and the second member 8, and receives and transfers the sound signal. The first winding mechanism 5 and the second winding mechanism 6 can wind the first connection member 7 and the second connection member 8, respectively.

The amplifier 3 includes an orientation member 31 relating to the orientation slot 23 for secure engagement. The orientation member 31 protrudes from the amplifier 3 and is shaped as a clamp; the orientation slot 23 is recessed from the housing 2 to accommodate the orientation member 31. The microphone 4 is capable of being received in the orientation recess 24 after retraction. The microphone 4 receives sounds via the cutout 241 thereby.

With respect to FIG. 3, the earpiece 21 is hung on speaker's ear as a general wireless earphone. The amplifier 3 can be aligned with the earhole of the speaker, and the microphone 4 can be adjacent to and facing a speaker' mouth.

With respect to FIG. 2, the present invention maintains the wireless earphone as a loud speaker, for easily preventing feedback problems due to a short distance between the amplifier 3 and the microphone 4. The first connection member 7 and the second connection member 8 can be respectively extended via the first winding mechanism 5 and the second winding mechanism 6; thus the distance between the amplifier 3 and the microphone 4 is increased. The control bottom 25 can enlarge the sound signal from the amplifier 3; the wireless earphone can thus be used somewhere far from the speaker, such as instruments of a vehicle.

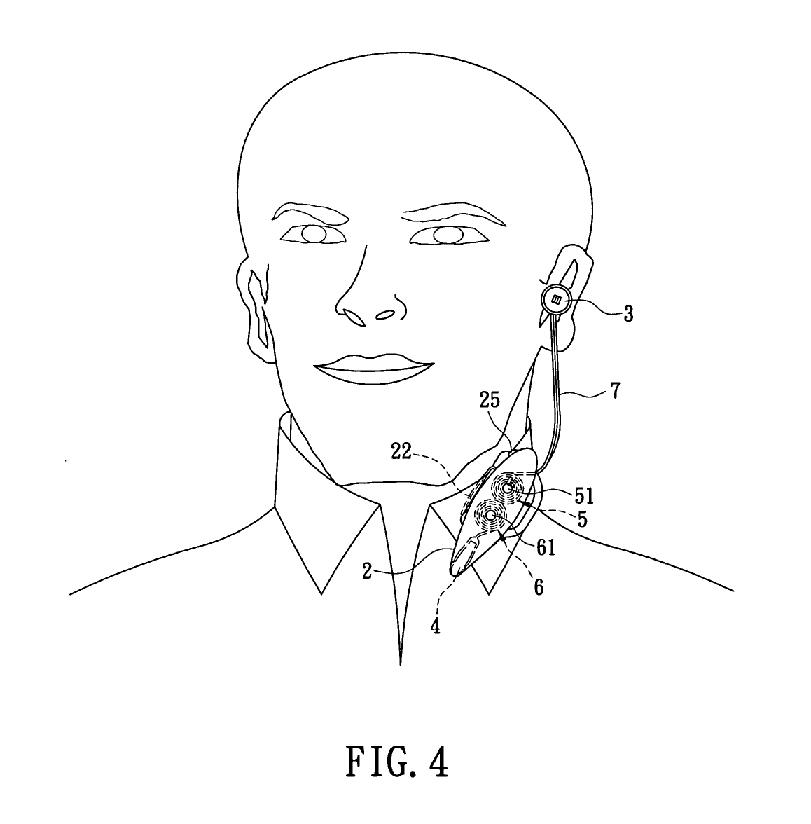

Illustrated in FIG. 4, the wireless earphone includes a clamping member 22 arranged on the housing 2 for clipping onto a user's clothes. The amplifier 32 can be extended via the first winding mechanism 5 to plug into the ear hole of a speaker.

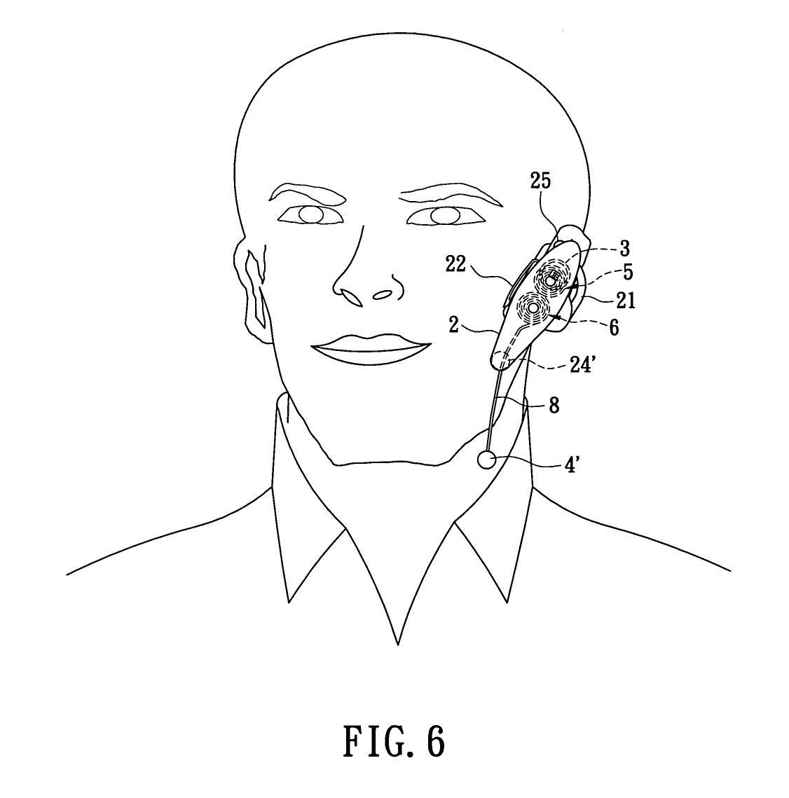

Referring to FIG. 6, the microphone 4 can be extended to be near a speaker's throat via the second winding mechanism 6, so that the microphone can be used as both a general and a throat vibration microphone. A microphone 4′ that is a throat vibration microphone can be received in an orientation recess 24′.

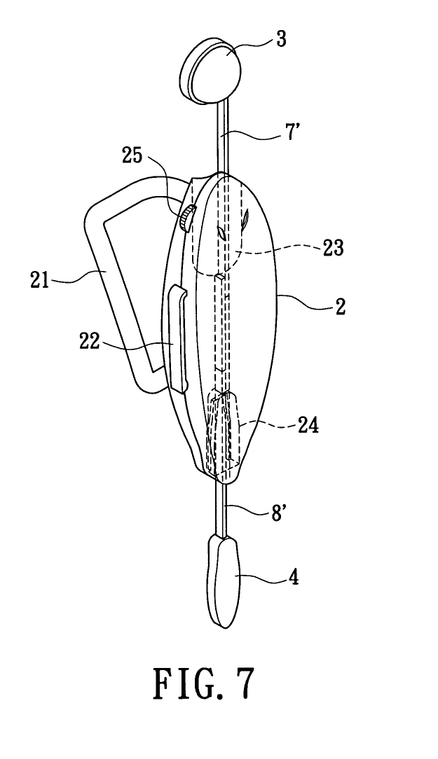

Referring to FIG. 7, the first connection member 7 and the second connection member 8 that are originally made of soft materials, can be replaced by a first connection member 7′ and a second connection member 8′ that are stiff and strip-like to have a signal cable received therein. The first connection member 7′ and the second connection member 8′ still can pass through two ends of the housing 2 freely, and the amplifier 3 and the microphone 4 can retract or extend thereby.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A wireless earphone of alternating extension and retraction functions, comprising:
a housing having a earpiece;
an amplifier;
a first connection member capable of being alternatingly extended from and retracted into the housing, wherein the first connection member electrically connects the amplifier and the housing;
a microphone; and
a second connection member capable of alternatingly being extended from and retracted into the housing and opposite to the first connection member, wherein the second connection member electrically connects the microphone and the housing.

2. The wireless earphone with alternating extension and retraction functions as claimed in claim 1, further including a first winding mechanism and a second winding mechanism both disposed inside the housing, wherein each of the first connection member and the second connection member is of a cable type for electrical connection to the first winding mechanism and the second winding mechanism, respectively.

3. The wireless earphone with alternating extension and retraction functions as claimed in claim 2, wherein the first winding mechanism and the second winding mechanism are separated from each other in the housing, and the first winding mechanism and the second winding mechanism are disposed on upper and lower portions thereof, respectively.

4. The wireless earphone with alternating extension and retraction functions as claimed in claim 2, wherein the first winding mechanism and the second winding mechanism are parallel to each other in the housing, and the first winding mechanism and the second winding mechanism are disposed on two lateral portions of the housing, respectively.

5. The wireless earphone with alternating extension and retraction functions as claimed in claim 1, wherein the housing includes an orientation slot formed therein, and the amplifier includes an orientation member relating to the orientation slot for secure engagement.

6. The wireless earphone with alternating extension and retraction functions as claimed in claim 5, wherein the orientation member protrudes from the amplifier and is shaped as a clam, and the orientation slot is recessed from the housing to accommodate the orientation member.

7. The wireless earphone with alternating extension and retraction functions as claimed in claim 1, wherein the housing includes an orientation recess formed therein to accommodate the microphone.

8. The wireless earphone with alternating extension and retraction functions as claimed in claim 1, wherein the microphone is in a general or a throat vibration microphone.

9. The wireless earphone with alternating extension and retraction functions as claimed in claim 1, further including a clamping member arranged on the housing.

10. The wireless earphone with alternating extension and retraction functions as claimed in claim 1, wherein the first winding mechanism and the second winding mechanism are stiff and strip-like to have a signal cable received therein.
